(19) United States
(12) Patent Application Publication
(10) Pub. No.: US 2016/0098884 A1
(43) Pub. Date: Apr. 7, 2016

(54) ELECTRONIC CONTAINER VENDING SECURITY SYSTEM

(71) Applicant: Air Liquide Advanced Technologies U.S. LLC, Houston, TX (US)

(72) Inventors: Joshua LAVRA, Walnut Creek, CA (US); Giuseppe LIBERATI, Houston, TX (US)

(21) Appl. No.: 14/508,359

(22) Filed: Oct. 7, 2014

(51) Int. Cl. G07F 11/00; G07F 9/02

(52) U.S. Cl. CPC G07F 11/002; G07F 9/026

(57) ABSTRACT

A security system for vending containers is provided including a modular vending unit, that includes a rotatable container storage and dispensing unit, an access means capable of switching between a locked state and an unlocked state, and disposed to cooperate with the rotatable storage and dispensing unit, a control unit for communicating with a user and the at least two modular vending units. an electronic selection means disposed to allow the acquisition or return of a container, an electronic control means for rotating and locking the rotatable container storage and dispensing unit, and an electronic control means for locking and unlocking the access means. The security system for vending containers also includes an alarm system mounted within the modular vending unit for detecting attempted theft and vandalism that may include a door sensor, a vibration sensor, an audio transducer means, a visual transducer

### BACKGROUND

The present invention relates generally to vending and dispensing machines and in particular to such a machine for vending a compressed gas cylinders, such as those used in welding.

Standard pressurized gas cylinders, such as the type typically used for shielding gas for welding and for cutting, pose vending problems. These cylinders have a cylindrically shaped tank, a valve at the top of the tank, and a guard substantially encircling the valve and providing a pair of lifting handles. The guard typically has a diameter smaller than the diameter of the outer surface of the tank. These standard cylinders can be relatively heavy, at least 20 pounds, possibly as heavy as 50 pounds.

It is the common practice for an individual, or small business, to acquire or exchange such pressurized gas cylinders at a store front. This can be inconvenient if the demand arises when the store is not open. Therefore, there is a need in the industry for a means for such small quantity users to obtain such cylinders around the clock, in a convenient and secure manner.

### SUMMARY

A security system for vending containers is provided including a modular vending unit, that includes a rotatable container storage and dispensing unit, an access means capable of switching between a locked state and an unlocked state, and disposed to cooperate with the rotatable storage and dispensing unit, a control unit for communicating with a user and the at least two modular vending units. an electronic selection means disposed to allow the acquisition or return of a container, an electronic control means for rotating and locking the rotatable container storage and dispensing unit, and an electronic control means for locking and unlocking the access means. The security system for vending containers also includes an alarm system mounted within the modular vending unit for detecting attempted theft and vandalism that may include a door sensor, a vibration sensor, an audio transducer means, a visual transducer.

### DETAILED DESCRIPTION

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

An electronic container vending machine includes at least one modular vending unit. This modular vending unit is capable of incrementally rotating and locking in predetermined positions, and includes multiple discrete storage volumes each configured to contain a single container. This modular vending also includes an access means for accessing the interior of the rotatable container storage and dispensing unit, that is capable of switching between a locked state and an unlocked state, and that is configured to cooperate with the rotatable storage and dispensing unit. The modular vending unit also includes a control unit for communicating with a user and the at least one modular vending unit.

The control unit includes an input means and an output means, and an electronic container inventory means configured to indicate a quantity of available containers, and a quantity of unoccupied storage volumes. The electronic container inventory means may include RFID tags on the available containers. The electronic container inventory means may include a QR code reader.

The control unit also includes an electronic selection means configured to allow the acquisition or return of a container, including an electronic control means for rotating and locking the rotatable container storage and dispensing unit, and an electronic control means for locking and unlocking the access means. The electronic selection device may be a multi-touch screen display. The electronic payment interface may include a credit card payment interface. The electronic payment interface may include an NFC payment interface.

The control unit also includes an electronic payment interface configured to allow for payments or refunds, and an access permission means configured to rotate the rotatable container storage and dispensing unit to a predetermined position, and allow access to the discrete storage volume by modulating the access means.

The containers may be a compressed gas cylinders. The compressed gas cylinders may contain a welding gas mixture. The welding gas mixture may be argon, carbon dioxide, oxygen, helium, nitrogen, or mixtures thereof. The compressed gas cylinder may contain acetylene.

A method of acquiring gas containers from an electronic container vending machine. This method includes receiving an input from a user by means of an input device, indicating a desired gas container of a specific size and containing a specific gas composition. Then determining the availability of the desired gas container with an electronic container inventory means. Then indicating the availability of the desired gas container to the user by means of an output means. Then receiving a user payment to an electronic payment interface. A discount or promotional value may be accepted via QR reader interface. Then delivering the desired gas container through an access permission means, thereby rotating a rotatable container storage and dispensing unit to a predetermined position, and switching an access means from a locked state and an unlocked state.

The rotatable container storage and dispensing unit may be capable of incrementally rotating and locking in predetermined positions, including multiple discrete storage volumes each configured to contain a single container.

The input device may include an electronic selection means configured to allow the acquisition or return of a container, comprising an electronic control means for rotating and locking the rotatable container storage and dispensing unit, and an electronic control means for locking and unlocking the access means.

The electronic selection device may include a multi-touch screen display.

The electronic container inventory means may be configured to indicate a quantity of available containers, and a quantity of unoccupied storage volumes. The electronic container inventory means may include RFID tags on the available containers. The electronic container inventory means may include a QR code reader.

The electronic payment interface may be configured to allow for payments or refunds. The electronic payment interface may include a credit card payment interface. The electronic payment interface may include an NFC payment interface.

The access permission means may be configured to rotate the rotatable container storage and dispensing unit to a predetermined position, and allow access to a discrete storage volume by modulating the access means.

One module may house oxygen and other inert gases, while a different module may house acetylene, other combustible gases, and inert gases. The module with the acetylene may be equipped with a lower explosive limit (LEL) meter.

The modules may have provisions for monitoring temperatures and thereby activating ventilation fans under conditions of high ambient or module internal temperatures. Safety alarms may be generated by the system.

In one embodiment of the present invention a security system for vending containers is provided. This system includes a modular vending unit, that includes a rotatable container storage and dispensing unit, capable of incrementally rotating and locking in predetermined positions, including multiple discrete storage volumes each disposed to contain a single container. Also included is an access means for accessing the interior of the rotatable container storage and dispensing unit, capable of switching between a locked state and an unlocked state, and disposed to cooperate with the rotatable storage and dispensing unit.

The vending system also includes a control unit for communicating with a user and the at least two modular vending units. The control unit includes a power supply, an input means and an output means. The vending system also includes an electronic container inventory means disposed to indicate a quantity of available containers, and a quantity of unoccupied storage volumes. The vending system includes an electronic selection means disposed to allow the acquisition or return of a container, includng an electronic control means for rotating and locking the rotatable container storage and dispensing unit, and an electronic control means for locking and unlocking the access means.

The vending system also includes an electronic payment interface disposed to allow for payments or refunds, and an access permission means disposed to rotate the rotatable container storage and dispensing unit to a predetermined position, and allow access to the discrete storage volume by modulating the access means.

The security system for vending containers also includes an alarm system mounted within the modular vending unit for detecting attempted theft and vandalism. The alarm system may include a door sensor means for providing a signal in response to the access means opening. The alarm system may include a vibration sensor means for providing a signal in response to vibration or shock. The alarm system may include an audio transducer means for generating a loud audible sound. The alarm system may include a visual transducer means for providing a highly visible indication of the state of the alarm, the visual transducer means including at least two status lights of different colors.

The alarm system may include an alarm circuit means for establishing an idle mode for machine servicing, an armed mode in which the alarm is set during normal operation, and a detected mode occurring when an act of vandalism or theft is properly detected. The alarm circuit means may include a means for receiving and analyzing the signals from the door sensor means and the vibration sensor means; a means for activating the audio transducer means; and a means for activating the visual transducer means in response to a proper detection of intrusions including means for differently activating the lights of different colors according to the mode of the alarm.

The alarm system may include a sensor to detect the loss of power to the vending machine. The alarm system may include a camera disposed to capture images of the exterior of the vending machine. The alarm system may include magnetic contact switches between the containers and the storage volume. The alarm system may include remote alarm notification.

What is claimed is:

1. A security system for vending containers, comprising:
a modular vending unit, comprising a rotatable container storage and dispensing unit, capable of incrementally rotating and locking in predetermined positions, comprising multiple discrete storage volumes each disposed to contain a single container,
an access means for accessing the interior of said rotatable container storage and dispensing unit, capable of switching between a locked state and an unlocked state, and disposed to cooperate with said rotatable storage and dispensing unit,
a control unit for communicating with a user and said at least two modular vending units, comprising:
a power supply, an input means and an output means,
an electronic container inventory means disposed to indicate a quantity of available containers, and a quantity of unoccupied storage volumes,
an electronic selection means disposed to allow the acquisition or return of a container, comprising an electronic control means for rotating and locking said rotatable container storage and dispensing unit, and an electronic control means for locking and unlocking said access means.
an electronic payment interface disposed to allow for payments or refunds, and
an access permission means disposed to rotate said rotatable container storage and dispensing unit to a predetermined position, and allow access to said discrete storage volume by modulating said access means, and
an alarm system mounted within said modular vending unit for detecting attempted theft and vandalism.

2. The security system of claim 1, wherein said alarm system further comprises a door sensor means for providing a signal in response to said access means opening.

3. The security system of claim 1, wherein said alarm system further comprises a vibration sensor means for providing a signal in response to vibration or shock.

4. The security system of claim 1, wherein said alarm system further comprises an audio transducer means for generating a loud audible sound.

5. The security system of claim 1, wherein said alarm system further comprises a visual transducer means for providing a highly visible indication of the state of the alarm, said visual transducer means comprising at least two status lights of different colors.

6. The security system of claim 1, wherein said alarm system further comprises an alarm circuit means for establishing an idle mode for machine servicing, an armed mode in which the alarm is set during normal operation, and a detected mode occurring when an act of vandalism or theft is properly detected, said circuit means comprising:
means for receiving and analyzing the signals from said door sensor means and said vibration sensor means; and,
means for activating said audio transducer means; and,
means for activating said visual transducer means in response to a proper detection of intrusions comprising means for differently activating said lights of different colors according to the mode of the alarm.

7. The security system of claim 1, wherein said alarm system further comprises a sensor to detect the loss of power to the vending machine.

8. The security system of claim 1, wherein said alarm system further comprises a camera disposed to capture images of the exterior of the vending machine.

9. The security system of claim 1, wherein said alarm system further comprises magnetic contact switches between the containers and the storage volume.

10. The security system of claim 1, wherein said alarm system further comprises remote alarm notification.
